(19) United States
(12) Patent Application Publication
(10) Pub. No.: US 2019/0219154 A1
(43) Pub. Date: Jul. 18, 2019

(54) ELECTROHYDRAULIC SYSTEM FOR OPERATING CLUTCH(ES) AND GEAR SELECTOR(S) OF SHIFT GEARBOXES

(71) Applicant: LSP Innovative Automotive Systems GmbH, Unterföhring (DE)

(72) Inventors: Thomas LEIBER, Rogoznica (HR); Valentin UNTERFRAUNER, München (DE); Rainer WINZER, München (DE); Carsten HECKER, München (DE)

(21) Appl. No.: 16/331,195

(22) PCT Filed: Feb. 28, 2017
(86) PCT No.: PCT/EP2017/054643

§ 371 Date: Mar. 7, 2019

(30) Foreign Application Priority Data
Sep. 7, 2016 (DE) 10 2016 116 778.9
Sep. 29, 2016 (DE) 10 2016 118 423.3

(51) Int. Cl. F16H 61/00; F16H 61/02; F16H 61/12; F15B 11/16; F16H 61/30; F16D 25/10; F16D 48/02; F16D 48/06; F04B 5/02; F04B 17/03

(52) U.S. Cl. CPC F16H 61/0031; F16D 2500/70406; F16H 61/12; F15B 11/16; F16H 61/30; F16D 25/10; F16D 25/14; F16D 48/062; F04B 5/02; F04B 17/03; F16H 2061/1264; F15B 2211/20515; F15B 2211/2053; F15B 2211/275; F15B 2211/6313; F15B 2211/633; F15B 2211/6651; F15B 2211/6653; F15B 2211/71; F16D 2500/1107; F16H 61/0206

(57) ABSTRACT

A shift gearbox, a control unit, and at least one electric motor-driven driven piston-cylinder unit with a piston, which delimits at least one working chamber, which is connected via hydraulic lines to multiple shift gearbox units of the shift gearbox and shifts these, wherein the shift gearbox units comprise at least one gear selector unit and at least one clutch units, characterised in that the control unit for shifting at least one of the shift gearbox units rotates the electric motor drive by a predetermined angle and the piston of the piston-cylinder unit is adjusted by a predetermined path (Δs) (path control) and the piston thereby conveys a required hydraulic volume to or from at least one shift gearbox unit.

The present invention relates to a shift gearbox, a control unit and at least one electric motor-driven piston-cylinder unit with a piston, which delimits at least one working chamber, which is connected via hydraulic lines to multiple shift gearbox units of the shift gearbox and shifts them, wherein the shift gearbox units comprise at least one gear selector unit and at least one clutch unit.

### PRIOR ART

From DE 10 2006 038 446 A1 a shift gearbox with an electric motor-driven piston-cylinder unit is described, in which one or two piston-cylinder units operate four gear selectors and two clutches. The piston-cylinder unit generates the pressure required to shift the gear selectors and clutches, wherein a pressure sensor measures the pressure generated. DE 10 2006 038 446 A1 describes two possible embodiments for this purpose. In the first embodiment clutches and gear selectors are shifted via so-called multiplex valves for an actuation, by means of the piston-cylinder unit. In this connection the pressure build-up and also the pressure reduction can take place via the piston-cylinder unit. However, it is also possible that additional outlet valves are provided for some or all loads, via which the pressure in the individual loads can be lowered in a regulated manner.

### OBJECT OF THE INVENTION

The object of the invention is to further improve the shift gearbox known from DE 10 2006 038 446 A1.

This object is achieved according to the invention with a shift gearbox having the features of claim 1. Advantageous embodiments of this shift gearbox are obtained from the features of the sub-claims.

Through the displacement control of the piston, which corresponds to a volume control, a cost-effective structure is provided in which the number of valves used can be advantageously reduced. On account of the displacement or volume control at least one shift gearbox unit can in a simple manner have more than two switching positions, without a complicated pressure control, since on account of the incompressibility of the hydraulic medium over a predetermined delivered volume the respective shift gearbox unit can be shifted specifically in one of the possible positions. Through the displacement or volume control the shift gearbox units can also be shifted accurately and quickly, and also components (switching valves, seals of piston units of gear selectors or clutch plates) can be diagnosed for leakage, as well as hydraulic flow resistances. Thus, it is advantageously possible that initially a rapid shifting is carried out, and by decelerating, the shift gearbox unit is smoothly shifted to its target position.

By the use of at least one pressure sensor, a pressure regulation for pressure build-up and also alternatively for pressure reduction can be provided for some shift gearbox units in an advantageous further development, so that by means of the same piston-cylinder unit a displacement control and/or a volume control and also a pressure control results. By additionally providing a pressure regulation using a pressure sensor, a precisely adjustable required force can also be applied to loads, such as, for example, the clutch.

Pressure regulation can also be achieved without the use of a pressure sensor via targeted piston displacement control or via targeted electrical energisation of the electric motor. In the pressure control, the non-linear relationship between pressure and piston adjustment path is recorded and stored in a performance map. This map is used in the pressure control in such a way that the piston travels a certain distance, which corresponds to a certain pressure. If the performance map changes due to temperature or air bubbles, it is recalibrated and recorded. Various methods are available for this, such as adjustment via pressure transducer, adjustment via path control, and use of the current of the electric motor.

Alternatively, a torque can be regulated via the current of the electric motor. For an accurate torque determination, the torque constant kt of the electric motor, which represents the relationship between the torque of the electric motor and phase current, can for example be used. The torque constant kt in the case of electric motors can be determined for example during manufacture or initial start-up and is characterised in that kt changes slightly over time and essentially changes linearly only due to temperature influences. As an alternative to the phase current, the supply current of the electric motor can also be used.

If no pressure sensor is available for the calibration, a pressure estimate can be made by means of a model. Such a model can according to the invention consist of a motor with a transmission, which for example presses on or possibly retracts a single-acting or double-acting hydraulic piston. For a sufficiently good pressure estimate for a gearbox unit, the parameters in the subunits (motor torque constant kt, transmission efficiency and hydraulic piston cross-sectional area, friction due to seals) must either be subjected to minor influences or the parameter variations must be adjusted at regular intervals.

An accurate model can be realised in such a way that the aforementioned parameter changes of the model, which interfere in the pressure estimation or pressure control, are detected during operation. For example, pressure sensors that are only active in partial operation or an indirect pressure calculation can be employed.

A method for the indirect measurement of the pressure via the current of the electric motor can be calculated by the position of the clutch piston in the slave cylinder and by the acting cross-sectional area of the piston of the master cylinder, by means of knowledge of the clutch release spring and the diameter of the clutch slave cylinder. Thus, a system based on a pressure transducer can be completely avoided, which leads to significant cost savings since pressure transducers are primary cost drivers of hydraulic systems. In series applications a pressure transducer is about 4 times more expensive than a switching valve and comparably expensive as a proportional valve.

By using a dual-action reciprocating piston, which can convey, via its two working chambers in both stroke directions of the dual-action reciprocating piston, hydraulic medium into or out of one of the shift gearbox units, inter alia a short design of the piston-cylinder unit can advantageously be achieved. Thus, the two piston surfaces can either have the same size, so that the same volume is conveyed with the same displacement of the piston during the forward stroke and the return stroke. It is however also possible that the piston surfaces have different sizes, e.g. in the ratio of 1.5-2:1, so that in the forward stroke 1.5 to 2 times the volume is conveyed as in the return stroke, so that in the forward stroke, volume can be conveyed faster in terms of a rapid pressure build-up and thus rapid actuation of the clutch or a rapid gear operation is promoted. In this way very short switching times of a double-clutch shift gearbox can be achieved, especially if at the same time in another clutch the pressure in the reservoir is reduced via a solenoid valve and the speed-torque characteristic curve of an electric motor can thus be optimally used for a given supply voltage.

Also, the volume ratio 2:1 can be used expediently in such a way that a volume compensation between two working chambers of a dual-action reciprocating piston can be achieved via a switching valve (31) and the axial force load on the shift gearbox is thus reduced, since in the forward stroke and in the return stroke only half the area acts on the shift gearbox unit. This is sensible especially at high pressures, since the axial force reduces the gear load and thus enables the use of a cost-effective plastic trapezoidal spindle drive. The advantage of the dual-action reciprocating piston compared to a continuously operating pump is that the pressure generating unit has to be operated only during a switching operation.

The following advantages can thus be achieved with the shift gearbox according to the invention:
a) Lower weight by reducing the number of components, especially by reducing the number of valves, sensors, filter, pressure accumulator and pump.
b) Improvement of the reliability by introducing diagnostic methods for leak testing and calibration methods for detecting a change in flow resistances
c) Reduction of Costs of the System
   Simplified gear position by using only two hydraulic piston-cylinder units (GS1 and GS2) for the actuation of more than 2 gear selectors (8-10 gears)
   Use of a cost-effective motor spindle unit for the pressure supply with trapezoidal spindle gears instead of recirculating ball gears
   Reduction of the number of sensors by the derivation of alternative measured variables such as motor current and motor piston position.
d) Functional Improvement
   Use of a position-controlled dual-action reciprocating piston as conveying unit for continuous conveyance for open systems
   Use of a position-controlled dual-action reciprocating piston as pressure supply with pressure reduction via the pressure supply unit for closed systems
   Optimal use of the torque-speed characteristic curve of an electric motor in the sense of a quick actuation of one or two clutches
e) Improved Reliability
   Diagnostic method for checking the components (valves, tightness of piston of the gear and clutch plates as well as the pressure supply unit), for tightness via piston control
   Measurement of the hydraulic system by measuring the hydraulic resistances in the system and detecting changes in operation
   Measuring methods for checking the flow resistances of the hydraulic system and its components (for example valves, lines) and determining the adjustment forces of the pistons of gear selectors and clutch actuators
f) Platform concept for automated gear shifting and dual clutches with as few changes as possible of the components in the system.

Advantageous possible embodiments of the shift gearbox according to the invention are explained in more detail with reference to the drawings, in which:

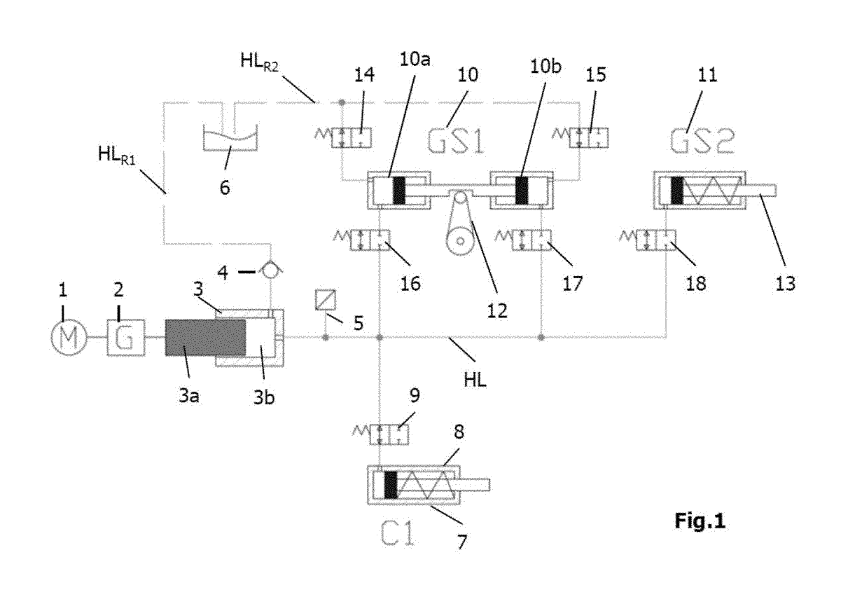

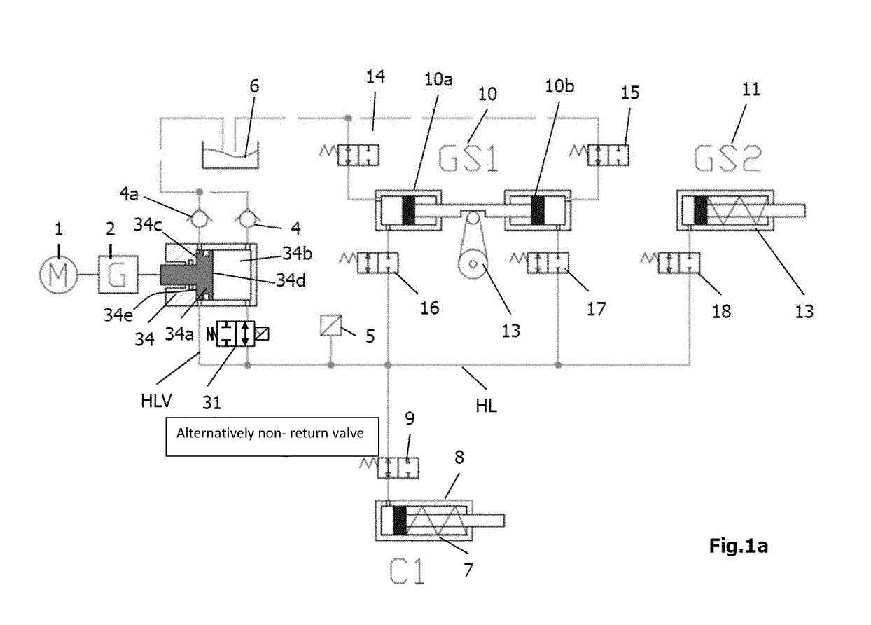

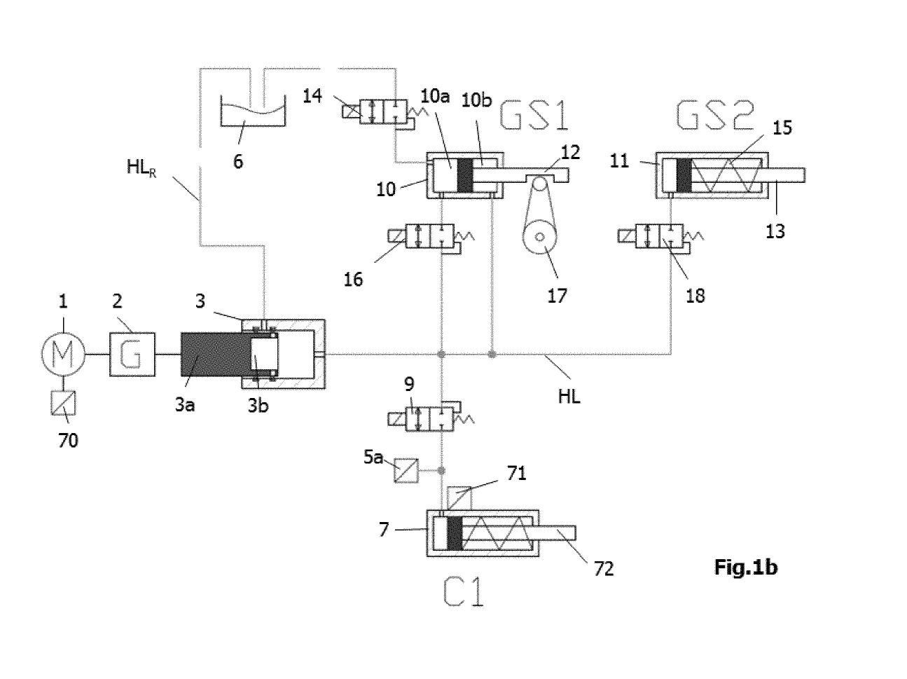

FIG. 1: System structure of an automated shift transmission gearbox (AMT) with clutch and gear selector;

FIG. 1a: System structure according to FIG. 1 with dual-action reciprocating pistons;

FIG. 1b: An automated shift transmission gearbox with clutch, gear selectors and four valves in the closed hydraulic circuit;

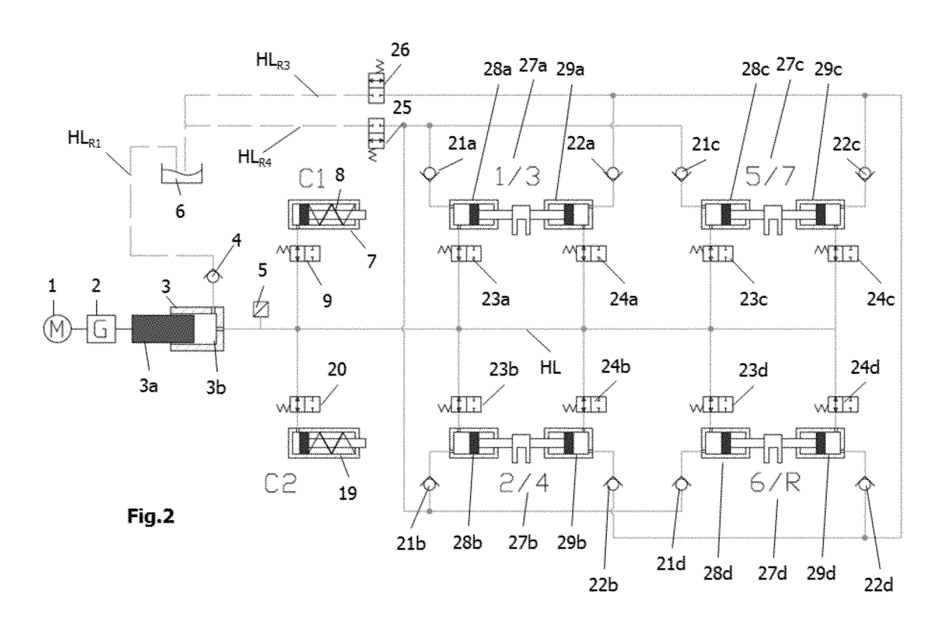

FIG. 2: System structure of an AMT (automated shift transmission) or double-clutch shift gearbox with one to two clutches as well as four gear selectors; the clutch is adjusted in multiplex mode in the closed hydraulic circuit;

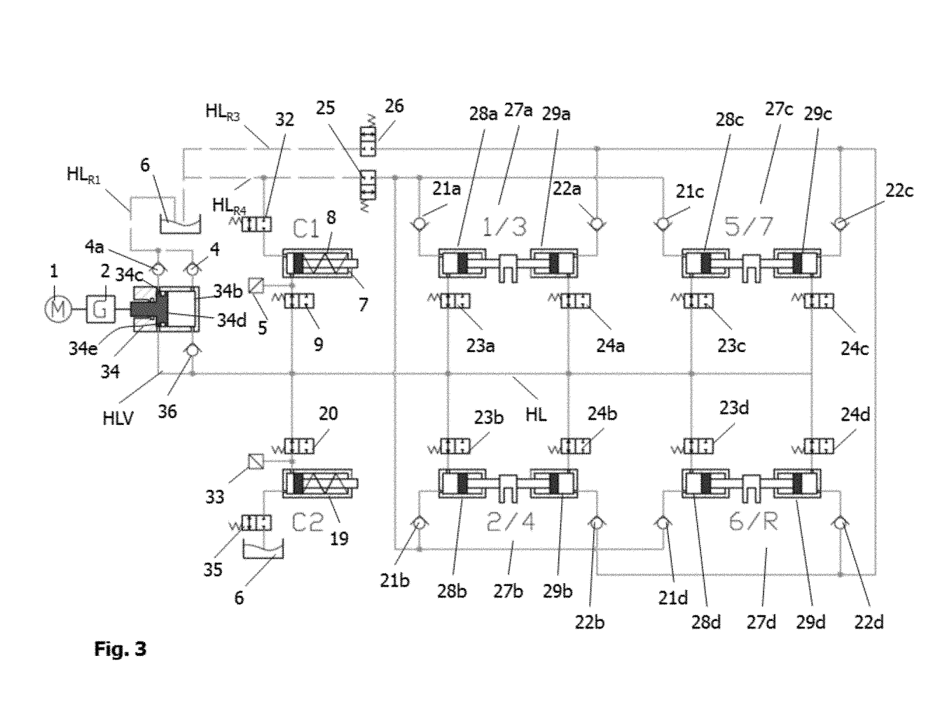

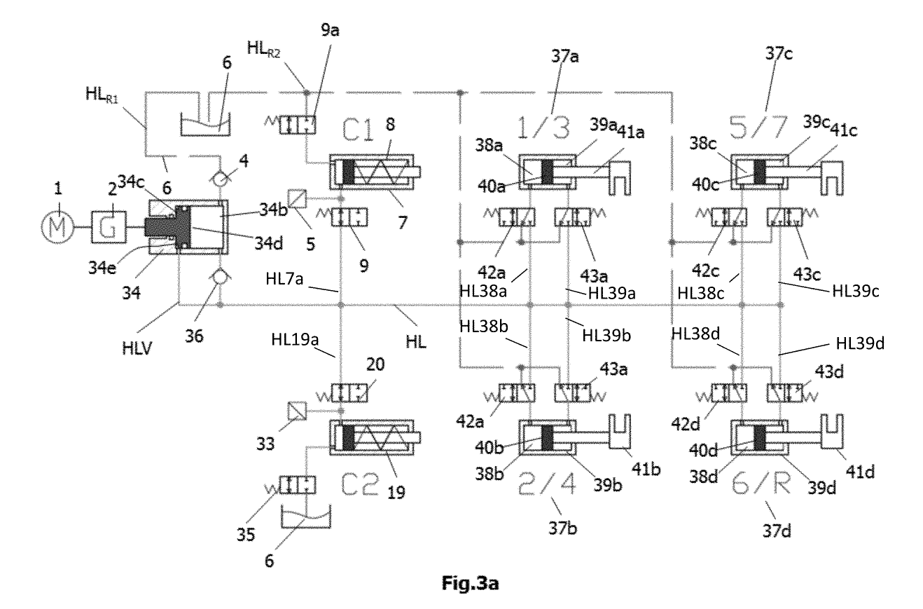

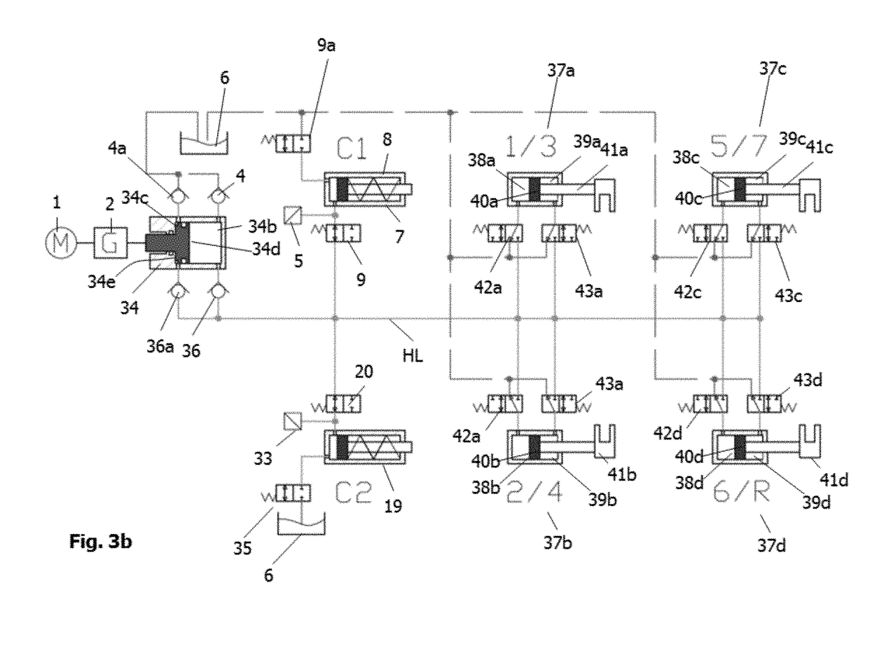

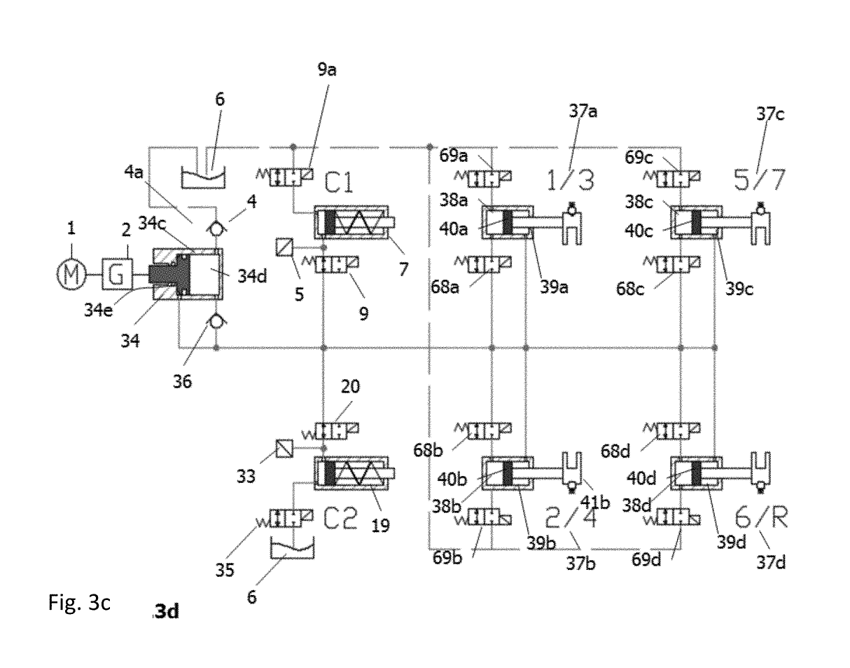

FIG. 3: System structure of an AMT (automated manual transmission) or DCT (double-clutch transmission) with one to two clutches and four gear selectors, in which the actuation of the clutches occurs via inlet and outlet valves;

FIG. 3a: System structure with gear selectors with double-acting piston, in which the piston surfaces of the dual-action reciprocating piston are the same size;

FIG. 3b: System structure with different size piston surfaces of the dual-action reciprocating piston;

FIG. 3c: System structure as FIG. 3a, but with 2/2-way valves instead of 3/2-way valves;

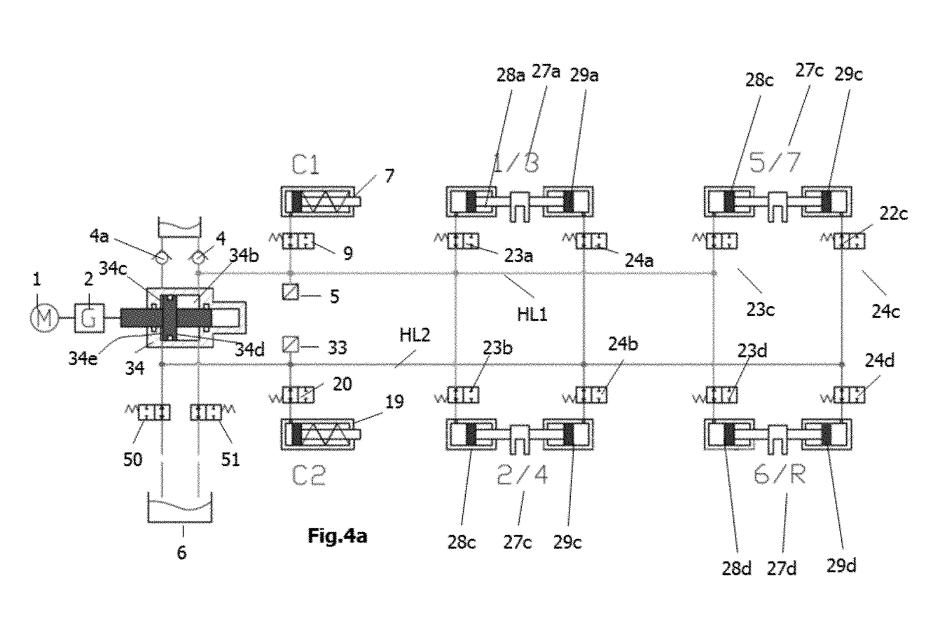

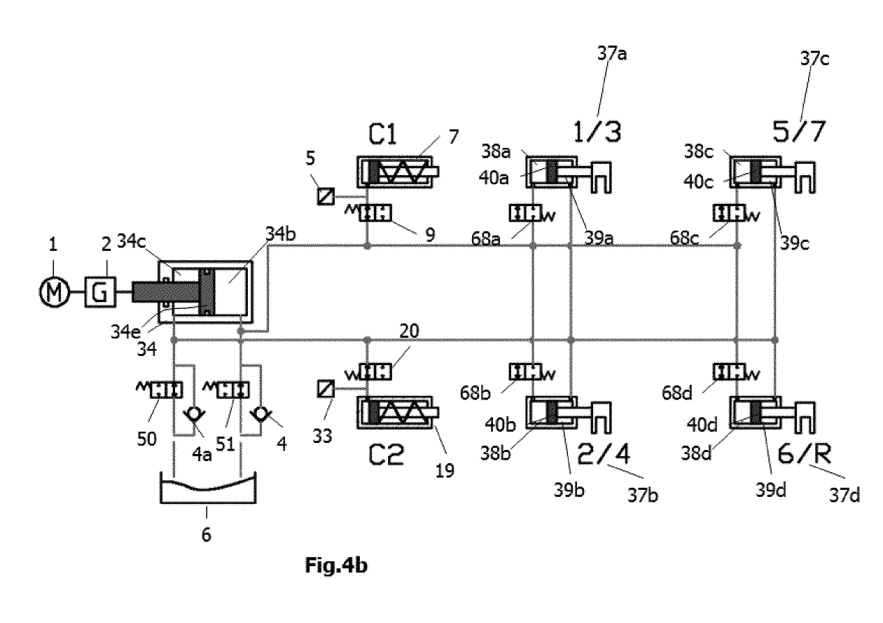

FIG. 4a: System structure of an AMT (automated shift transmission) or DCT (double-clutch transmission) with one to two clutches as well as four gear selectors, in which the actuation of the clutches occurs by means of inlet and outlet valves via a double-acting piston with a ratio of the piston surfaces of 1:1 or suitably chosen other ratio, e.g. 1:2;

FIG. 4b: System structure as in FIG. 4 but with only one 2/2-way valve per gear selector instead of two, wherein in each case only one chamber of the dual-action reciprocating piston is hydraulically connected in each case to only one chamber of a gear selector;

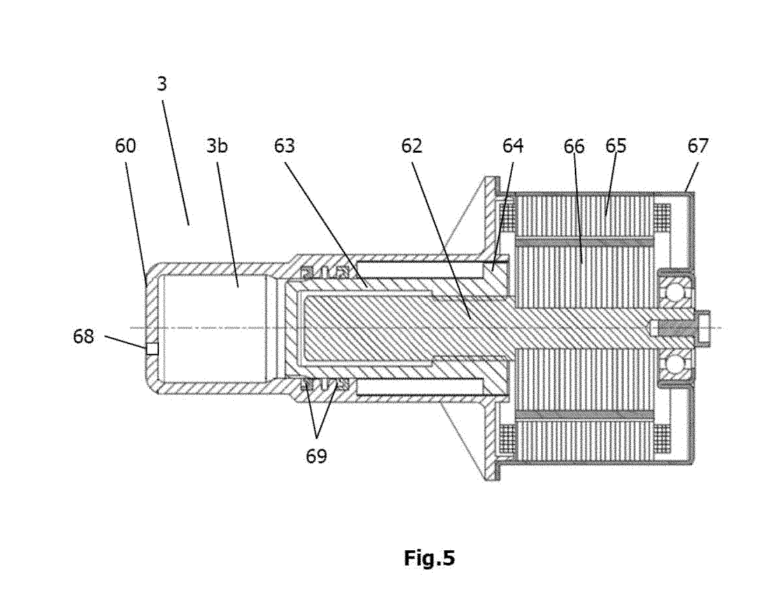

FIG. 5 Cross-sectional view of a possible embodiment of a pressure supply unit, in which a spindle is driven by an electric motor, in particular a BLC motor, whereby by means of preferably a trapezoidal thread drive a piston is displaced in a pressure chamber.

FIG. 1 shows a first possible embodiment of the shift gearbox according to the invention, which is designed as an automated shift gearbox. Here, an electric motor-driven actuating unit consisting of motor 1, shift gearbox 2 and piston-cylinder unit 3 actuates a clutch 7 and two gear selector units 10, 11, which in turn actuate a gear selector mechanism 12, 13. The motor 1 is activated only during a switching operation, whereby the system does not have to be permanently in operation, as is the case with systems with pumps and a pressure accumulator unit. The gear selectors 10, 11 may have two or more positions, to which the gear selector mechanisms 12, 13 can be adjusted. Normally the gear selector 10 has the positions left, middle, right. On the other hand, the gear selector 11 may also have more than three positions. By conveying predetermined fluid volumes in or out, the gear selector mechanisms 12, 13 can thus be adjusted from a starting position to a target position, in which the volume of fluid necessary for this is conveyed or displaced by the piston-cylinder unit 3.

The electric motor-driven actuating unit 1, 2 is for reasons of cost and space preferably in the form of a trapezoidal screw drive, alternatively executed by means of a ball screw drive or similar types of gears.

The hydraulic piston-cylinder unit 3 is actuated with the aid of the electric motor-driven actuating unit 1, 2, wherein here a pressure control takes place by using the pressure sensor 5. By adjusting a target pressure by means of the piston 3a (reducing the working chamber 3b) the fluid is displaced from the working chamber 3b via a 2/2-way valve 9 in the direction of the clutch unit 7 and thus opens the unpressurised closed clutch, which is monitored via the centrally arranged pressure sensor 5.

After actuation of the clutch 7, the 2/2-way valve 9 is closed and the clutch 7 is thus held in the open state.

By opening the 2/2-way valve 16 and closing the 2/2-way valve 14 further volume can be displaced via the piston-cylinder unit 3 into the cylinder 10a of the gear selector unit 10, whereby a rotation is exerted on the gear selector mechanism 12, which preferably has three possible switch positions. For this purpose, the 2/2-way valves 15 must be opened and the 2/2-way valve 17 must be closed at the same time. To adjust the gear selector, no pressure control is applied by means of the pressure sensor 5 however, but a volume control is carried out by driving the piston by a predetermined distance Δs, so that a defined amount of fluid is displaced into the cylinder 10a or 10b of the gear selector, whereby the gear selector mechanism 12 is rotated by a certain angle and thus to its desired set position.

In order to complete the switching process further, fluid is displaced via the 2/2-way valve 18 into the gear selector unit 11, whereby the gear selector mechanism 13 is moved to one of preferably three possible switching positions, preferably to one of the two end positions, whereby a spring 14 of the gear selector 11 is tensioned. Here too a volume control is applied, so that separate sensors for detecting the gear selector position could be dispensed with, which however may not be sensible in some cases, so that it is completely within the meaning of the invention to provide such position sensors at one or both gear selectors 10, 11. Only a slight pressure is needed to compensate for the spring forces of the piston-cylinder unit 3. The resetting of the gear selector 11 to its initial position can be carried out by the tensioned spring alone.

After the engagement of the selected gear via the gear selector mechanism 12, 13, the 2/2-way valve 9 is opened and the volume contained therein is moved back via the piston-cylinder unit 3 to its working chamber 3b, whereby the clutch 7 moves back in a controlled manner to its starting position and thus closes. Through the check valve 4 volume can be aspirated from a reservoir 6 into the piston-cylinder unit 3.

FIG. 1a shows a second possible embodiment of a shift gearbox according to the invention, which is a modification of the shift gearbox according to FIG. 1. Instead of a piston-cylinder unit with only one working chamber, the second embodiment has a dual-action reciprocating piston 34a, which hermetically separates the two working chambers 34b, 34c from one another. The two working chambers 34b, 34c are connected to one another by means of a connecting line HLV, wherein a switching valve 31 is arranged in the connecting line. The two piston surfaces 34d, 34e delimiting the working chambers 34b, 34c are of different sizes, the piston surface 34e being 1.5 to 2 times smaller than the piston surface 34d. In the return stroke of the piston 34a (move to the left) and with the switching valve 31 closed, the fluid or hydraulic medium is thus conveyed from the working chamber 34c to the hydraulic line HL. In the forward stroke, i.e. when adjusting the piston 34a to the right, the switching valve 31 must be open, whereby the piston 34a conveys fluid from the working chamber 34b to the hydraulic line HL or HLV. Since however the other working chamber 34d increases and the pressure in the hydraulic line is greater than the atmospheric pressure, fluid flows from the hydraulic line HL into the working chamber 34c. If the piston surface ratio of the piston surfaces 34d, 34e is 2:1, just as much hydraulic medium is conveyed to the respective shift gearbox unit in the forward stroke as in the return stroke.

When pressure is reduced in the gear selector 10 via the outlet valves 14, 15, with the valves 16, 17 closed, pressure can be built up at the same time in the clutch 7 and the other gear selector 11.

FIG. 1b shows another possible embodiment of the shift gearbox according to the invention, which is designed as an automated shift gearbox. Here, an electric motor-driven actuating unit consisting of a motor 1 with rotation angle sensor 70, shift gearbox 2 and piston-cylinder unit 3 operates a clutch 7 and two gear selector units 10, 11, which in turn actuate a gear selector mechanism 12, 13. The motor 1 is activated only during a switching operation, whereby the system does not have to be permanently in operation, as is the case with systems with pumps and a pressure accumulator unit. The gear selectors 10, 11 may have two or more positions into which the gear selector mechanisms 12, 13 can be shifted. The gear selector 10 normally has two to three positions. On the other hand, the gear selector 11 can also have more than three positions. By conveying predetermined fluid volumes in or out, the gear selector mechanisms 12, 13 can thus be adjusted from a starting position to a target position, wherein the volume of fluid necessary for this is conveyed or displaced by the piston-cylinder unit 3.

The electric motor-driven actuating unit 1, 2 is for reasons of cost and space preferably in the form of a trapezoidal screw drive, or alternatively implemented by means of a ball screw drive or similar types of shift gearbox.

The hydraulic piston-cylinder unit 3 is actuated by means of the electric motor-driven actuating unit 1,2. The regulation of the individual hydraulic units in the form of the clutch 7 and gear selector 10, 11 is carried out via the piston movement for conveying the required hydraulic volumes. In this case the displaced volume can be calculated via the piston travel of the actuating unit 3 and therefore need not be measured individually with sensors in the individual hydraulic receivers 10a, 10b, 11, 7. This means that the function of the AMT actuator can only take place with an angle sensor 70 in the motor-shift gear-box-piston unit. Sensors such as for example a pressure transducer 5a or position sensor 71 in the clutch 7 can be used for diagnosis and can guarantee the functionality or evaluate the state of the system. However, they are not absolutely necessary. Assuming that the clutch actuator valve 9 has a leakage and the clutch 7 opens slowly, this can be determined by means of the differential rotational speed of the crankshaft and vehicle gearbox and an additional position or pressure sensor (5a, 71) is therefore not absolutely necessary. In addition, position sensors P1, P2 can also be provided at the gear selectors GS1 and GS2, which can be provided for example for leakage testing. These can however also be used instead of pressure transducers to control the position of the gear selector. In all embodiments which are shown and described in the figures, corresponding sensors Pi can be provided with the gear selectors, which can fulfil the above mentioned functions.

After actuation of the clutch 7, the 2/2-way valve 9 is closed and the clutch 7 is thus held in the open state.

By opening the 2/2-way valve 16 and closing the 2/2-way valve 14, which is closed current-free, further volume can be displaced via the piston-cylinder unit 3 to the cylinder 10a of the gear selector unit 10, whereby a rotation is exerted on the gear selector mechanism 17, which preferably has three switching possibilities. For this purpose, the 2/2-way valves 14 must be opened at the same time and the 2/2-way valve 16 must be closed. However, for adjusting the gear selector, no pressure control by means of a pressure sensor is used, but a volume control is carried out by driving the piston by a predetermined distance Δs, so that a defined amount of fluid is displaced into the cylinder 10a or 10b of the gear selector, whereby the gear selector mechanism 17 is rotated by a certain angle and is thus rotated to its required position.

In order to complete the switching process further fluid is displaced via the 2/2-way valve 18 to the gear selector unit 11, whereby the gear selector mechanism 13 is moved to one of preferably three possible switching positions, preferably to one of the two end positions, whereby a spring 15 of the gear selector 11 is tensioned. In this case as well a volume control is applied, so that separate sensors for detecting the gear selector position could be dispensed with, which however is not expedient in some cases, so it is completely within the meaning of the invention to provide such position sensors with one or both gear selectors 10, 11. Only a slight pressure is required to compensate the spring forces of the piston-cylinder unit 3. The resetting of the gear selector 11 to its initial position can be done by the tensioned spring alone.

After engaging the selected gear via the gear selector mechanism 12, 13, the 2/2-way valve 9 is opened and the volume contained therein is displaced via the piston-cylinder unit 3 back to its working chamber 3b, whereby the clutch 7 moves back in a controlled manner to its starting position and thus closes. Through the check valve implemented as a collar seal on the piston, volume can be aspirated from a reservoir 6 into the piston-cylinder unit 3. An excess of volume can thus be generated in the closed hydraulic system, which restricts the pressure or also the position control in the further course of events. Excessive volume can be drained via the valves 14 and 16 into the reservoir. Alternatively, the hydraulic piston 3 can for this purpose also drive into a position while the clutch 7 is depressed, where a pressure reduction is subsequently executed without any problem.

FIG. 2 shows a third possible embodiment of the shift gearbox according to the invention which is designed as a double-clutch gearbox. In contrast to FIG. 1, in each case two gears are selected via a gear selector. Preferably four to five gear selectors (7- or 9-speed shift gearbox) are installed in a system.

In the initial state preferably one of the two clutches 7, 19 is closed, whereas the other is in the open state.

With a gear change from first to second gear, volume is displaced via the hydraulic piston-cylinder unit to the hydraulically open gear selector system. The inlet valves of all gear selectors and the currently not activated clutch 19 are closed. By opening the 2/2-way valve 23b and simultaneously opening the outlet valve 26, the second gear is engaged by displacement of the piston in the gear selector 27b, following which the valve 23b is closed. A displacement or pressure control of the piston can be carried out here. For the change from first to second gear, volume is now displaced from the piston-cylinder unit 3 to the preferably hydraulically closed clutch unit system. The clutch C1 7 is closed and thus the first gear of the gear selector 27a is in the power train. The clutch C2 19 is in the open state in the starting position. By means of two 2/2-way valves 9, 20 the pressure reduction in clutch 7 and sequentially the pressure build-up in clutch 19 is carried out in the so-called multiplex operation. The pressure sensor 5 serves in this case for the pressure-volume control. For a gear change from second to third gear again all the inlet valves of the clutches and gear selectors as well as the outlet valve 26 are closed and the inlet valve 24a and the outlet valve 25 are opened. Via the control of the electric motor-driven actuating unit, the hydraulic fluid is displaced via the piston-cylinder unit to the piston chamber of the piston-cylinder unit 29a and third gear is thus engaged. The completion of the gear change operation is accomplished by opening or closing the clutches 7, 19 in multiplex mode.

A simplification of the hydraulic circuit diagram and a reduction in the number of valves is achieved by the use of one check valve per gear selector-piston chamber. In this connection for example the piston chambers of the gears 3, 4, 7, R can be hydraulically combined. A connection to the reservoir 6 is formed via an outlet valve 26.

FIG. 3 shows a third possible embodiment of the shift gearbox according to the invention, which is also designed as a double clutch drive.

In contrast to FIG. 2, the two clutches are implemented as a hydraulically open system with the additional outlet valves 32, 35. For this system two pressure sensors 5, 33 are installed to improve the pressure reduction control accuracy, each one sensing the pressure in the corresponding clutch. The pressure sensors 5, 33 are expediently arranged behind the inlet valves 9, 20. The change of gears is carried out as described in FIG. 2. The exemplary pressure build-up in clutch 7 is carried out as before via the control of the electric motor-driven actuating unit, whereby the hydraulic fluid is displaced via the piston-cylinder unit and the inlet valve 9 to the clutch 7. The pressure reduction at the other clutch 19 can be carried out via a PWM control of the outlet valve 35, whereby the pressure reduction gradient is determined. This has a significant influence on the closing behaviour of the clutch. The pressure sensor can be dispensed with since the initial pressure of the piston-cylinder unit of the clutch 7, which is adjusted via path control during the pressure build-up via path control, is stored and is released in a controlled manner in the pressure reduction via a hydraulic model by appropriate timing control of the outlet valves. For the control accuracy, the hydraulic resistances determined by the measurement method are used in the modelling of the hydraulic model.

The pressure build-up can also take place without a pressure transducer via a path control, in which the pressure-volume characteristic curve should then be taken into account and a pressure estimate is made by measuring the phase current of the electric motor. However, for safety reasons it is expedient to provide at least one pressure transducer also for adjusting the model.

The dual-action reciprocating piston can be implemented as a continuous pressure supply unit, which is used only as required, in which the check valves 4, 4a and 36 are employed. With an area ratio of the two piston surfaces or piston ring surfaces of 2:1, the same volume is conveyed to the system both in the forward stroke and the return stroke. In the forward movement of the dual-action reciprocating piston the volume is conveyed from the forward stroke piston 34b via the check valve 36 on the one hand to the return stroke chamber 34c, and on the other hand the other half of the volume is made available to the system. In a reverse movement of the dual-action reciprocating piston, volume is made available via the check valve 4 in the forward stroke chamber 34b and the volume is fed from the return stroke chamber 34c to the system.

On account of the hydraulic connection of the forward and return stroke chambers 34b, 34c, the effective piston area is the difference between the piston forward stroke surface and piston return stroke surface, or only the return stroke surface. This area must be taken into consideration for the design of the engine torque and/or the shift gearbox. The unit can be designed so that axial forces are reduced as much as possible, which can allow the use of a plastic transmission.

FIG. 3a shows a further fourth possible embodiment, which differs from the embodiment of FIG. 3 in that the four gear selectors 37a to 37d have double-acting piston-cylinder systems, wherein the directional valves 42a-d and 43a-d in one of their positions act as inlet valves and in their other position act as outlet valves, so-called 3/2 valves. In the inlet position the valve 42a-d connects the working chamber 38a-d to the hydraulic line HL and thus to the piston-cylinder unit 34. The same applies to the valves 43a-d, which in their first position connect the working chambers 39a-d to the hydraulic line HL. In their second positions the valves 42a-d and 43a-d connect the respective working chambers to the hydraulic line HL_{R2} and the reservoir 6.

FIG. 3b shows a fifth possible embodiment, in which the working chambers 34b, 34c are arranged with check valves 36, 36a connecting to the hydraulic line, so that only hydraulic medium can be conveyed to the hydraulic line with the drive unit 1, 2, 34 for the pressure build-up. If the piston surfaces 34d, 34e are of different sizes, more fluid is conveyed to the hydraulic line HL in the forward stroke than in the return stroke. The pressure reduction in the shift gearbox units takes place via the outlet valves 9a, 35 at the clutches 7, 19 and via the valves 42a-d and 43a-d. In this way a quicker pressure build-up or higher volume conveyance in the forward stroke than in the return stroke is possible. This can be used advantageously for fast or slow switching operations.

FIG. 3c shows a further embodiment of the shift gearbox according to the invention, which is also designed as a double-clutch gearbox. The pressure supply is implemented here in the form of a so-called dual-action reciprocating piston with two check valves 4, 36, wherein each further combination of valves for the dual-action reciprocating piston 34 can be selected.

In contrast to FIG. 3a the more expensive and often leak afflicted 3/2-way valves were replaced by cheap and low-leakage 2/2-way valves. These are used in modern braking systems and are preferred for diagnostic purposes. Due to the large production volumes these are very inexpensive and should therefore preferably be used. Here either valves directly from brake systems can be used, or valves with slight modifications, which can also be manufactured inexpensively and reliably as regards their functions. The operation of the clutches 7 and 19 is performed as described by means of the pressure supply unit 34. For the actuation of the gear selector 37a to the right, volume from the pressure supply unit 34 is conveyed via the open 2/2-way valve 68a and simultaneously closed 2/2-way valve 69a to the chamber 38a of the gear selector 37. Due to the differently large piston surfaces delimiting the working chambers 38a and 38b a differential force acts on the piston 40a, whereby the volume is conveyed from the chamber 39a of the gear selector 37a to the chamber 38a and the piston moves to the right. In order to move the gear selector 37a to the left, volume is conveyed from the pressure supply unit directly to the chamber 39a of the gear selector 37a. For this purpose, simultaneously the valve 69a must be open and the valve 68a must be closed.

FIG. 4a shows an eighth possible embodiment of the shift gearbox according to the invention, which is also designed as a double clutch drives.

In contrast to FIG. 3, a piston-cylinder unit is preferably driven in the embodiment of a double-acting piston unit 34 by the electric motor-driven actuator. In this case the so-called forward stroke chamber 34b with the clutch 7 and the return stroke chamber 34c with the clutch 19 are hydraulically connected. As regards the gear selectors, in each case one hydraulic chamber is connected to the forward stroke chamber 34b and the other hydraulic chamber is connected to the return stroke chamber 34c. Likewise two outlet valves 50, 51 are also provided, in each case in one of the two hydraulic circuits that are connected to the reservoir 6.

The volume from the forward stroke chamber 34b can conveyed via the 2/2-way valve 20 to the clutch 7. At the same time the volume can be displaced from clutch 19 to the return stroke chamber 34c. For a change of the pressure gradient the outlet valve 50 can in addition be electrically energized in PWM control. The closing or opening operation of the individual clutches can thus be influenced. On actuation of a gear selector the volume of the forward stroke chamber is used for example for the pressure build-up in a gear selector, and at the same time the volume is displaced from the second chamber of the gear selector to the return stroke chamber of the double-acting piston unit 34.

FIG. 4b shows a further embodiment of the shift gearbox according to the invention, which is also designed as a double-clutch gearbox. The pressure supply is implemented in the form of a dual-action reciprocating piston.

Preferably the piston 34e is in a middle position before the start of its travel, since it cannot be predicted whether first gear or reverse gear is engaged when the vehicle is started. Thus, for both manoeuvres a corresponding volume is present in the chambers 34b and 34c for actuating a gear selector and a clutch. Alternatively, the piston 34e would have to be moved to the correct position with the valves 50 and 51 open.

Contrary to the embodiment shown in FIG. 4, in each case the 2/2-valves 24a, 24b, 24c, 24d can be dispensed with. It is important in this connection that one chamber of the dual-action reciprocating piston is connected respectively to one chamber of each gear selector. Through this separate arrangement of the connecting lines HL1 and HL2, a gear change can be executed as follows. For a gear change from first to second gear, first of all second gear must be engaged. For this, the piston 34a is moved to the left, whereby volume is displaced to the gear selector 2/4. The valve 68b is in this case also opened to allow the shift of the gear selector 2/4, since otherwise the gear selector 2/4 would be hydraulically locked. As soon as second gear is engaged, the piston 34e is shifted further to the left and volume is displaced via the 2/2-way valve 20 to the clutch C2 19, which leads to the closure of the clutch C2 19. At the same time the clutch C1 must be opened. For this, the 2/2-way valve 9 is opened and the volume is displaced from there either to the increasingly larger piston chamber 34b, or alternatively the valve 51 is additionally opened, whereby the pressure in the reservoir can be reduced. After the clutch C2 is completely closed and the clutch C1 is opened, the next gear can be preselected. In order now to engage third gear, the dual-action reciprocating piston 34 is moved to the right, whereby volume is conveyed through the open valve 68a to the chamber 38a of the gear selector 37a. The volume from the chamber 39a of the gear selector is at the same time conveyed to the chamber 34c of the dual-action reciprocating piston.

FIG. 5 shows a cross-sectional representation through a possible embodiment of a pressure supply unit 3, in which a spindle 62 is driven by an electric motor (stator 65, rotor 66), in particular a BLC motor. The electric motor is arranged substantially in the housing half 67.

The spindle 62 is connected to the rotor 66 and drives the axially displaceably mounted spindle nut 63, which is arranged in a torque-proof manner with its collar in the second housing part 60. The spindle nut 63 forms as it were with its front end 64 the piston of the piston-cylinder unit. The working chamber 3b is delimited by the first housing part 60 and the piston 64. Seals 69 ensure that no fluid can move in the direction of the electric motor 65, 66. A trapezoidal spindle 63 made of plastic is preferably used, since only low pressures have to be built up for a shift gearbox and thus only small forces are exerted. The working chamber 3b is connected to the hydraulic line HL, not shown, via the channel 68.

The spindle nut 63 of the pressure supply unit according to FIG. 5 can also drive a dual-action reciprocating piston via a push rod, which hermetically divides the working chamber 3b into two working chambers, wherein a partition, which is penetrated by the push rod, must then also be introduced between the spindle nut and the working chamber 3b. In addition to the channel 68 another channel must then be provided in the housing 60, which connects the second formed working chamber to the hydraulic lines.

### LIST OF REFERENCE NUMERALS

1 EC motor
2 shift gearbox
3 piston-cylinder unit
4, 4a check valve with hydraulic connection to the reservoir 65
5a pressure sensor
6 reservoir
7 clutch unit 1
8 return spring clutch unit 1
9 2/2-way valve
10 gear selector unit 1 (rotational movement)
10, 10b piston-cylinder units of the gear selector 10
11 gear selector unit 2 (linear movement)
12 gear mechanism 1 rotation (3 positions)
13 gear mechanism 2 translation (3 positions)
14-17 2/2-way valve
19 clutch unit 2
20 2/2-way inlet and outlet valves
21a-d check valve
22a-d check valve
23a-d inlet valve
24a-d inlet valve
25 outlet valve
26 outlet valve
27a gear selector (1/3 gear)
27b gear selector (2/4 gear)
27c gear selector (5/7 gear)
27d gear selector (6/R gear)
28a-d left piston-cylinder unit of the gear selector 27a-d
29a-d right piston-cylinder unit of the gear selector 27a-d
31 2/2-way valve
32 outlet valve
33 pressure sensor
34 double-acting piston-cylinder unit
34a dual-action reciprocating piston
34b, 34c working chambers of the piston-cylinder unit 24 with dual-action reciprocating piston 34a
34d, 34e piston surfaces of the dual-action reciprocating piston 34
35 outlet valve
26 check valve
37a-d gear selector
38a-d first working chamber of the piston-cylinder unit of the gear selector 37a-d
39a-d second working chamber of the piston-cylinder unit of the gear selector 37a-d
40a-d piston of the piston-cylinder unit of the gear selector 37a-d
41a-d piston rod of the piston-cylinder unit of the gear selector 37a-d
42a-d 2/2-way inlet and outlet valve for first working chamber 38a-d
43a-d 2/2-way inlet and outlet valve for second working chamber 39a-d
46 2/2-way valve
50, 51 2/2-way valve
60 first housing part
61 working chamber
62 spindle
63 spindle nut also forms the piston
64 collar of the spindle nut for torque bracing
65 stator
66 rotor
67 second housing part
68a-d 2/2-way inlet and outlet valve for gear selector 37a-d
69a-d 2/2-way inlet and outlet valve for gear selector 37a-d
70 angle of rotation sensor for motor commutation
71 position transducer of the clutch actuator C1
72 pistons of the clutch actuator C1
HLxxx hydraulic line
HL1, HL2 main hydraulic line
HLR1,2 hydraulic feedback of the pressure regulator unit
HLR3,4 hydraulic feedback of the gear selector unit
P1, P2 sensors, in particular position sensors, e.g. Hall switch

1. An electrohydraulic shifting system, comprising:
a shift gearbox,
a control unit and
at least one electric motor-driven piston-cylinder unit with a piston, which delimits at least one working chamber, which is connected via hydraulic lines to multiple shift gearbox units of the shift gearbox and shifts these,
wherein the shift gearbox units comprise at least one gear selector unit and at least one clutch unit,
wherein the control unit for shifting at least one of the shift gearbox units controls the electric motor drive in such a way that the drive rotates by a predetermined angle or the piston of the piston-cylinder unit is adjusted by a predetermined distance and the piston thereby conveys a required hydraulic volume to or from at least one shift gearbox unit.

2. Shift gearbox according to claim 1, wherein for shifting at least one other shift gearbox unit, the control unit measures by means of a pressure sensor the actual pressure (pᵢₛₜ) in a hydraulic line or the shift gearbox unit or calculates the pressure via the phase current of the electric motor, transmission and mechanical shift gearbox losses between the engine and piston and also effective piston area of the piston-cylinder unit, and controls the drive of the piston-cylinder unit in such a way that a target pressure (p_{target}) or target phase current (i_{target}) is adjusted or regulated in the at least one other shift gearbox unit.

3. Shift gearbox according to claim 1, wherein the piston-cylinder unit has a dual-action reciprocating piston, and the dual-action reciprocating piston hermetically separates two working chambers from each other, and both working chambers are in communication or can be brought into communication with the hydraulic line or hydraulic lines connecting the shift gearbox units.

4. Shift gearbox according to claim 3, wherein the dual-action reciprocating piston hermetically separates the first and the second working chamber from each other, wherein the effective piston area delimiting the first working chamber is larger or smaller than the effective piston area delimiting the second working chamber.

5. Shift gearbox according to claim 3, wherein one working chamber of the dual-action reciprocating piston is hydraulically connected to a first clutch and the other working chamber is hydraulically connected to a further clutch.

6. Shift gearbox according to claim 3, wherein in addition to the clutch each working chamber is connected to a pressure chamber of a gear selector and the other working chamber is connected to the respective other second working chamber of the gear selector.

7. Shift gearbox according to claim 3, wherein the two working chambers delimited by the piston surfaces of the dual-action reciprocating piston are different in size, in particular have a size ratio of at least 1.5:1, particularly preferably 2:1.

8. Shift gearbox according to claim 7, wherein the pressure in a clutch plate is reduced by the dual-action reciprocating piston, in which the piston is driven in such a way that the volume of one working chamber is increased and the working chamber of the second working chamber is reduced, or conversely the volume of one working chamber is reduced and that of the other working chamber is increased.

9. Shift gearbox according to claim 3, wherein the pressure in a clutch plate is reduced via the dual-action reciprocating piston or the volume of a chamber of a gear selector is at least partially conveyed to the reservoir, in which at least one working chamber of the dual-action reciprocating piston is in communication via an open solenoid valve with the reservoir.

10. Shift gearbox according to claim 9, wherein the two working chambers of the piston-cylinder unit are connected to one another via a hydraulic line, in which a switching valve or a check valve is arranged, wherein the check valve is arranged in such a way that on reduction of the working chamber, which is delimited by the larger piston surface, hydraulic medium can flow through the check valve or switching valve into the other working chamber.

11. Shift gearbox according to claim 10, wherein at least one shift gearbox unit has a neutral position and more than two switching positions, wherein the control unit adjusts the more than two switching positions by means of path control of the piston.

12. Shift gearbox according to claim 11, wherein at least one shift gearbox unit, in particular each shift gearbox unit, can be shut off separately by means of a switching valve associated therewith, with respect to the other shift gearbox units and the piston-cylinder unit.

13. Shift gearbox according to claim 12, wherein at least one or both working chambers of the piston-cylinder unit is/are connected by means of a hydraulic line to a storage reservoir for hydraulic medium, and a switching valve or a check valve is arranged in the respective connecting line.

14. Shift gearbox according to claim 13, wherein the piston-cylinder unit with its dual-action reciprocating piston serves for the pressure build-up/volume conveyance in at least one shift gearbox unit and for the simultaneous pressure reduction/volume removal in at least one other shift gearbox unit.

15. Shift gearbox according to claim 14, wherein the control unit in the volume or path control of the piston employs no pressure sensor and/or in the pressure control evaluates and takes into account by means of a pressure sensor the pressure volume characteristic curve of the control process shift gearbox units relevant in each case in the regulation procedure.

16. Shift gearbox according to claim 15, wherein the control unit adjusts the gear selectors of the shift gearbox using the path control of the piston.

17. Shift gearbox according to claim 16, wherein the control unit for adjusting at least one of the shift gearbox units controls the electric motor drive, wherein the control variable for the regulation of the drive is the angle of rotation of the drive, the motor electric current flowing through the drive, the piston position (s) and/or the travel (Δs) of the piston, and the piston thereby conveys a required hydraulic volume to or from at least one shift gearbox unit.

18. Shift gearbox according to claim 1, wherein the controller uses a model for pressure calculation, wherein the model for determining the control variable for the drive for a pressure to be adjusted in a clutch unit takes into account the motor current, the clutch spring stiffness and optionally the motor angle.

19. Shift gearbox according to claim 18, wherein the shift gearbox has at least one pressure sensor for balancing the control.

20. Shift gearbox according to claim 19, wherein from the hydraulic line at least one hydraulic supply line branches off this or extends this, which connects the main hydraulic line to a first working chamber of a shift gearbox unit, wherein in order selectively to shut off the hydraulic supply line a switchable valve, in particular a 2/2-way valve, is arranged therein.

21. Shift gearbox according to claim 20, wherein the second working chamber of a shift gearbox unit is in communication via a further hydraulic line with the main hydraulic main.

22. Shift gearbox according to claim 21, wherein a shift gearbox unit has a position sensor or setting sensor.

23. Shift gearbox according to claim 22, wherein the position sensor discretely determines the position of the piston of the shift gearbox unit, and in particular is a Hall switch.

24. Shift gearbox according to claim 22, wherein the signals of the position or setting sensor are used for controlling the drive and/or for calibrating the control and/or the simulation model.

25. Shift gearbox according to claim 24, wherein the control unit, the clutch plate of the shift gearbox builds up the pressure using the path control of the piston.

26. Shift gearbox according to claim 25, wherein the control unit reduces the pressure in a shift gearbox unit by opening one of the outlet switching valves associated with the shift gearbox unit or by adjusting the piston of the piston-cylinder unit.

27. Shift gearbox according to claim 26, wherein the transmission has a trapezoidal spindle and the pressure supply unit has a single piston or a dual-action reciprocating piston.

28. Shift gearbox according to claim 27, wherein each chamber of a shift gearbox unit is associated with a controlled 2/2-way valve, with which the chamber can optionally be connected or separated from the hydraulic line.

29. Shift gearbox according to claim 27, wherein the chamber of the pressure supply unit is in communication via a first hydraulic line with the chambers, and the chamber of the pressure supply unit is in communication via a second hydraulic line with the chambers, wherein a controlled 2/2-way valve is arranged in the connecting line connecting a chamber of a shift gearbox unit to the first hydraulic line.

30. Shift gearbox according to claim 29, wherein the piston of a shift gearbox unit hermetically separating the chambers from each other has two different sized effective piston surfaces, wherein in particular the piston area delimiting the chamber is smaller than the piston area delimiting the chamber.

31. Shift gearbox according to claim 28, wherein the first and/or the second hydraulic line can be connected by means of a switching valve with the storage reservoir, wherein in particular a check valve is connected in parallel to the switching valve.

32. Shift gearbox according to claim 31, wherein a gear selector has two working chambers, wherein the piston separating the two working chambers has two different sized effective piston surfaces and the gear selector is adjusted in one direction by opening the associated valve under constant pressure in the pressure supply unit and is closed for resetting the valve, and a valve to the reservoir is opened and the piston of the pressure supply unit is adjusted accordingly by means of the drive.

33. Shift gearbox according to claim 32, wherein the dual-action reciprocating piston has two different sized hydraulically acting piston surfaces, and a rapid pressure build-up or volume delivery takes place via the working chamber that is delimited by the larger piston surface.

34. Method for determining the tightness of at least one seal and/or valve function of the shift gearbox according to claim 33, wherein the tightness and function is checked periodically by means of the position-controlled piston-cylinder unit in the form of a plunger or dual-action reciprocating piston and/or using a pressure sensor.

35. Method according to claim 34, wherein by means of the piston-cylinder unit a pressure is built up in the hydraulic line and then the drive power of the piston drive is held constant for a period of time (Δt_{check}), wherein during the time (Δt_{check}) it is monitored whether either the piston position of the piston or the pressure determined by the pressure sensor changes, in particular the time behaviour of the change in position of the piston or the pressure profile is monitored and on the basis of this the tightness and/or the valve function is determined.

36. Method according to claim 34, wherein the method is carried out after the braking of the vehicle to zero speed, in particular during a brief vehicle standstill or after starting the vehicle.
